(19) United States
(12) Patent Application Publication
(10) Pub. No.: US 2004/0230466 A1
(43) Pub. Date: Nov. 18, 2004

(54) Adaptable workflow and communications system

(76) Inventors: James E. Davis, Atlanta, GA (US); Balasubramaniam Ganesh, Belmont, CA (US); Kenneth L. Holmes, San Francisco, CA (US)

Correspondence Address: PERKINS COIE LLP, P.O. BOX 2168, MENLO PARK, CA, 94026, US

(21) Appl. No.: 10/844,006

(22) Filed: May 11, 2004

Related U.S. Application Data
(60) Provisional application No. 60/469,932, filed on May 12, 2003.

(51) Int. Cl. G06F 17/60

(52) U.S. Cl. 705/8

(57) ABSTRACT

A data driven workflow solution that normalizes business communications by systematically recording related business communications from disparate communications channels in a common format such that the related business communications are automatically integrated into the associated business processes and which flow solution is flexible for capturing additional data elements or to adapt to changing tasks associated with the business processes is disclosed

### CROSS-REFERENCE TO RELATED APPLICATIONS; PRIORITY CLAIM

This application claims benefit of Provisional Application Serial No. 60/469,932, entitled ADAPTABLE WORKFLOW AND COMMUNICATIONS SYSTEM, by inventors, James E. Davis, Balasubramaniam Ganesh, and Kenneth L. Holmes, filed May 12, 2003, the entire contents of which is hereby incorporated by reference as if fully set forth herein, under 35 U.S.C. §119(e).

### FIELD OF THE INVENTION

The invention relates to business process tracking and automation, and more specifically to a system that enables rapid adaptation to changing business processes by tracking all related activities and communications. Such a system provides facilities to enable on-demand execution of automation functions. Business communications can be systematically recorded in a common format regardless of whether the original format is email, instant messaging, workflow application updates, voice conference, or other technology formats. In addition, the system framework enables interaction with other workflow applications including customer relationship management (CRM), enterprise resource planning (ERP), and information technology (IT) ticketing systems.

### BACKGROUND OF THE INVENTION

The acceptance of corporate instant messaging, the increasingly overwhelming volume of email, and the proliferation of enterprise workflow applications are making business communications more fragmented and inefficient. While each workflow and communications vehicle has advantages for specific types of business activities, there is no system that tracks and manages all of the related tasks and communications in a normalized form. Although integrated communications channel management has been addressed in specific niche areas, such as inbound customer communication to a call center, there is currently no holistic solution for managing disparate communications channels for any business process.

While there are many systems available to track work activities associated with a wide range of business processes, many of these systems do not capture the true work that is performed since much of the work is performed outside of the system. A great deal of the work activity typically involves communications between process participants, and since the communication is not consistently tracked, the communication needs to be entered into the system after the work has been performed.

Additionally, the available workflow systems do not provide the flexibility to keep pace with the rate of business change. Many of these systems require programming and database changes in order to capture additional data elements associated with a business process or to change what tasks are required to fulfill a specific type of service request.

Based on the foregoing, there is a need for a business tracking system that provides for systematically recording business communications from disparate communications channels in a common format such that business communications is automatically integrated into the associated business processes and for flexibility to capture additional data elements or to adapt to changing tasks associated with the business processes.

### BRIEF DESCRIPTION OF THE DRAWINGS

The present invention is illustrated by way of example, and not by way of limitation, in the figures of the accompanying drawings and in which like reference numerals refer to similar elements and in which.

FIG. 1 is a high level diagram illustrating a manner in which control data drives a request interface and consequent fulfillment tasks that are spawned, according to certain embodiments;

FIG. 2 is a simple high level conceptual diagram illustrating key object classifications in a Core Object model;

FIG. 3 illustrates sample attributes of the Core-Ticket object and the Message object, according to certain embodiments;

FIG. 4 is a schematic illustration of the Messaging architecture that provides an integrated messaging framework for uniform messaging capabilities, according to certain embodiments;

FIG. 5 illustrates the manner in which the Relationship object functions, according to certain embodiments;

FIG. 6 illustrates a Core-Group table and the objects that the Core-Group table relates, according to certain embodiments;

FIG. 7 illustrates a Core-Other table 710 and the objects that the Core-Other table relates, according to certain embodiments;

FIG. 8 illustrates a Core-Assets table and the objects that the Core-Assets table relates, according to certain embodiments;

FIG. 9 illustrates a Core-Documents table and the objects that the Core-documents table relates, according to certain embodiments;

FIG. 10 illustrates a Core-People table and the objects that the Core-People table relates, according to certain embodiments;

FIG. 11 shows the relationship between Core objects, according to certain embodiments;

FIG. 12 illustrates a composite view if different core objects that are related by relationship tables, according to certain embodiments;

FIG. 13 shows the worker user interface that presents the normalized task and communications data, according to certain embodiments;

FIG. 14 shows the detailed task interface that presents all of the attributes, messages and relationships associated with a single task, according to certain embodiments;

FIG. 15 is a schematic that illustrates the use of integrating tools and other terminal emulators, according to certain embodiments.

### DETAILED DESCRIPTION OF THE PREFERRED EMBODIMENT

A data driven workflow solution that normalizes business communications by systematically recording related business communications from disparate communications channels in a common format such that the related business communications are automatically integrated into the associated business processes and which flow solution is flexible for capturing additional data elements or to adapt to changing tasks associated with the business processes is described.

In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Business process tracking and automation is made possible by a common object model and an associated unified user interface. The common object model include key objects such as core objects that provide relations ships between other core objects and/or a standard sets of objects, relationship objects for defining the relationships between objects, and message objects for providing unified messaging. Such a common object model not only provides a unified view of all related components within the model, but also provides a data driven work flow solution for the given business process and automation.

According to certain embodiments, a system is used for establishing a common data model to track and manage all forms of service requests, tasks, data objects and related business communications. In order to provide a data driven workflow solution, the system is designed to enable data updates to drive the following:

The information that is collected based on the type of service requested;

The tasks, and related dependencies, that are created based on the type of service that has been requested;

The information that needs to be collected for each specific type of task;

The automation functions that should be executed based on specific events;

The automation functions that should be available to the task assignee based on the task type;

The validation criteria of any data element;

The notifications that should be sent based on specific events.

All system communications are normalized to a common structure that includes two high-level objects, a core object, and a message object. There are different types of core objects. The different types of core objects include:

1 ) Core-ticket object;

2) Core-group object;

3) Core-other object;

4) Core-assets object;

5) Core-documents object;

6) Core-people object.

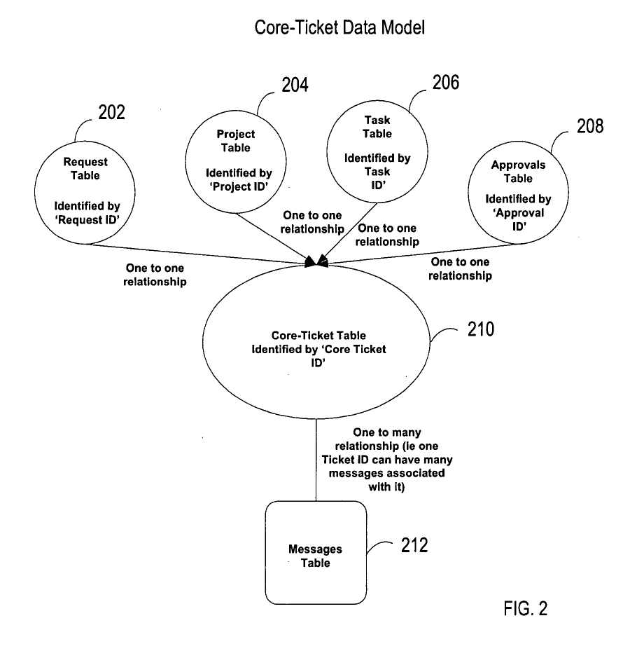

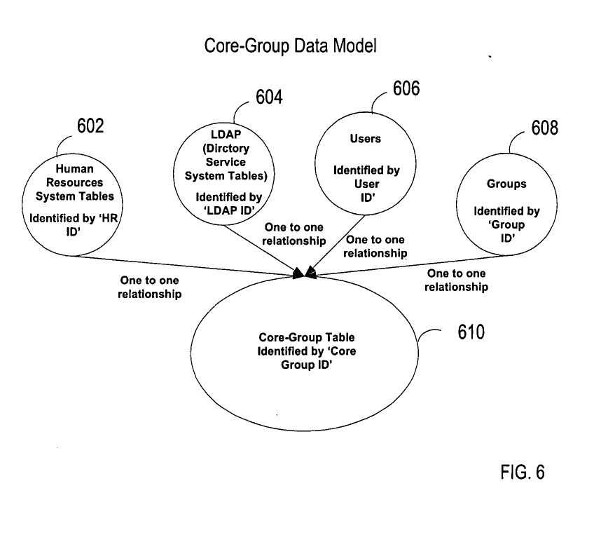

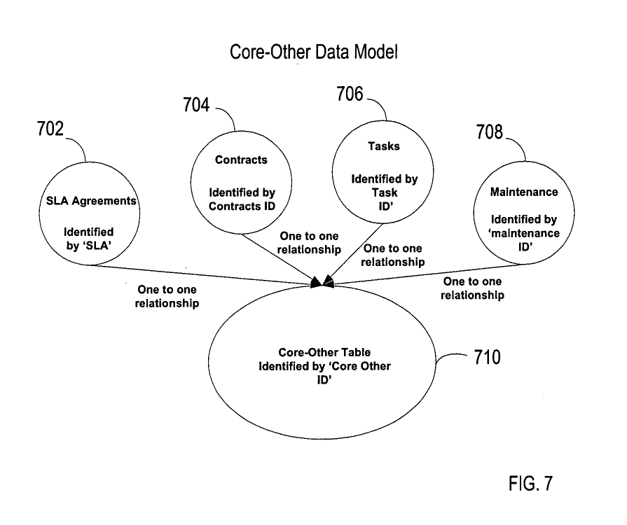

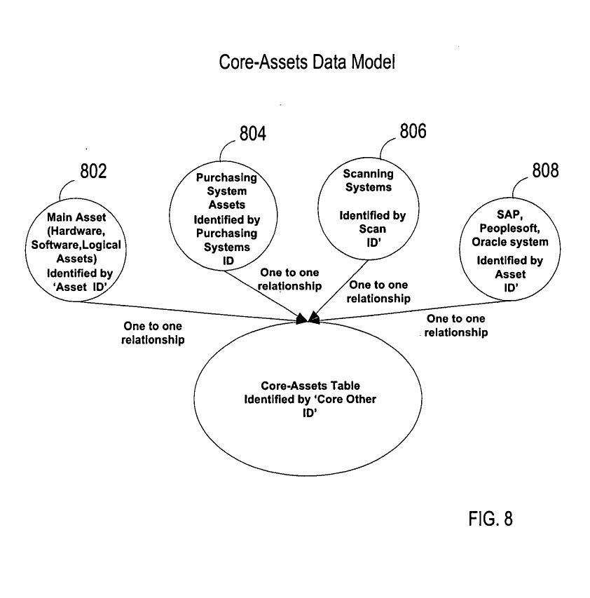

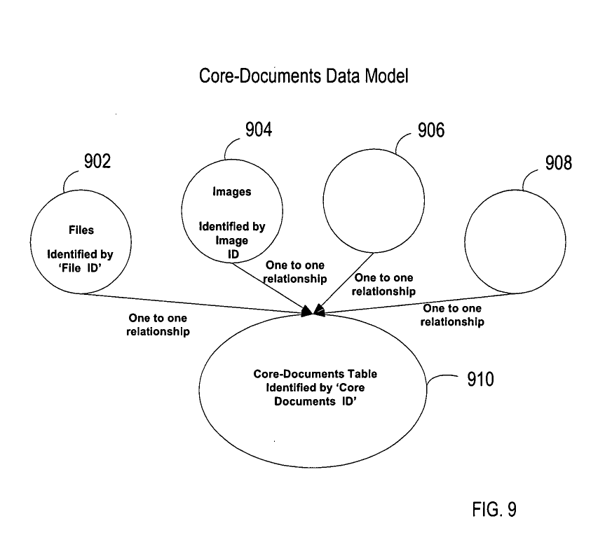

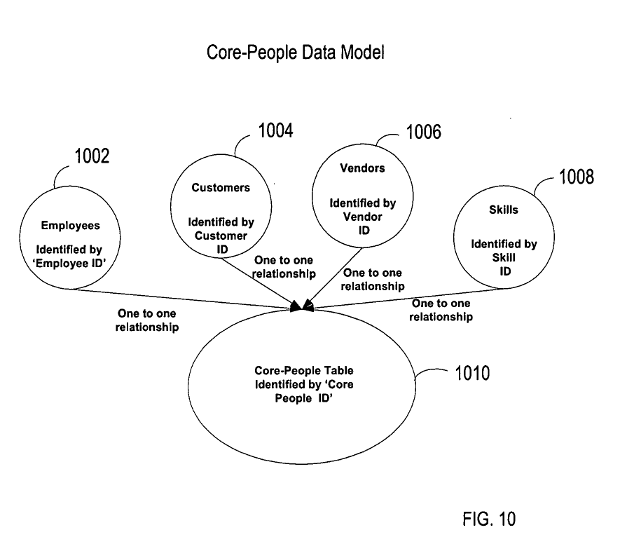

The above different types of core objects are merely illustrative. The different types of core objects depend on the particular business needs of a project or company and thus may vary from implementation to implementation. The present invention is not limited to any particular type of core objects. The different core objects are described in greater detail herein with reference to FIG. 2, FIG. 6, FIG. 7, FIG. 8, FIG. 9 and FIG. 10.

Core objects provide a framework for relationships between a standard set of objects. Core objects can also provide a framework for relationships between other core objects. The standard set of objects can include objects such as a Request object, Project object, Task object, and Approvals object. The standard set of objects is described in greater detail with reference to FIG. 2. The above standard set of objects is merely illustrative. The standard set of objects depends on the particular business needs of a project or company, and thus may vary from implementation to implementation. The present invention is not limited to any particular standard set of objects.

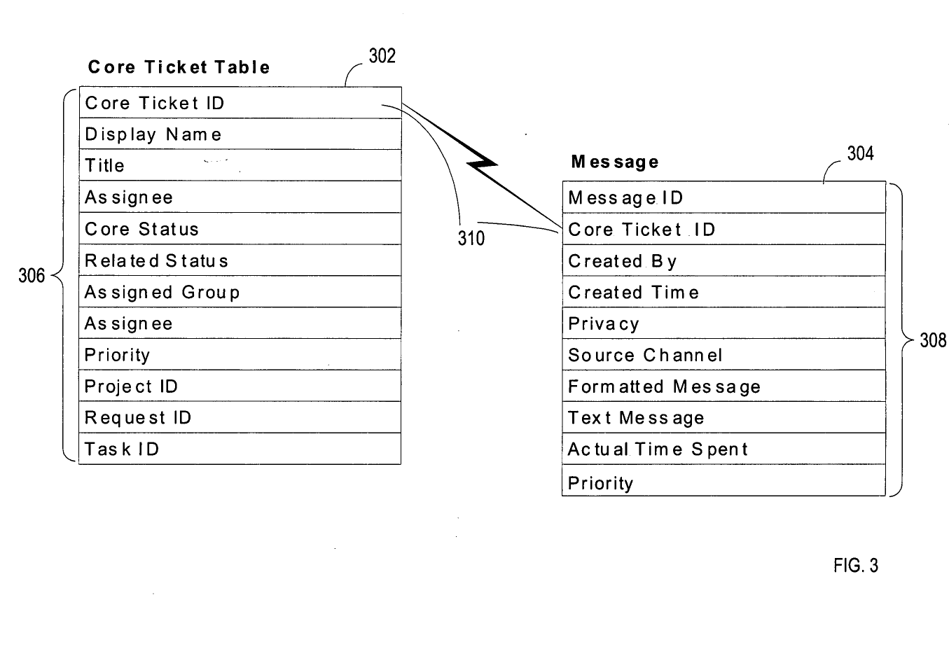

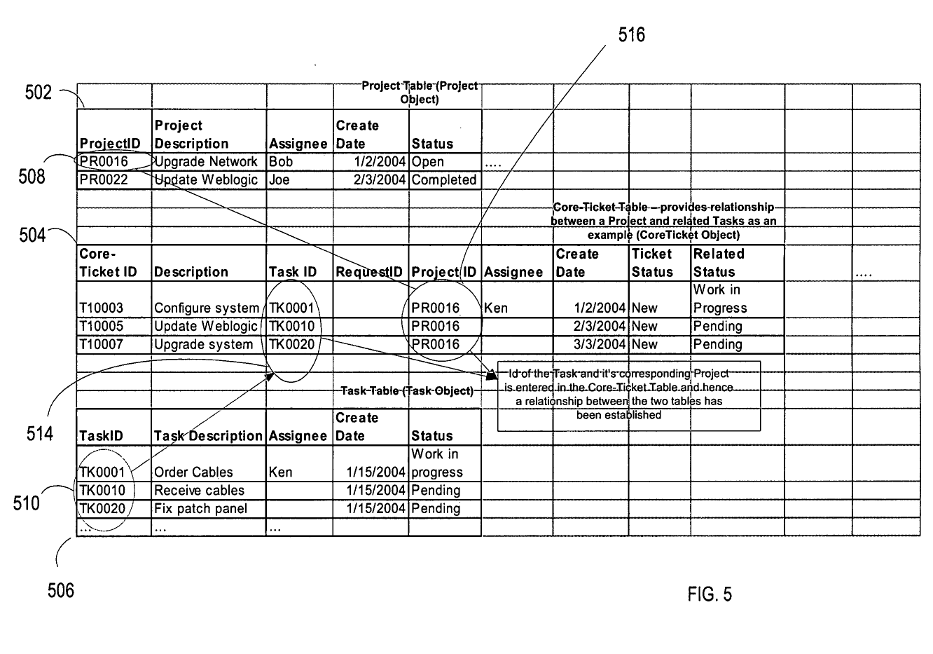

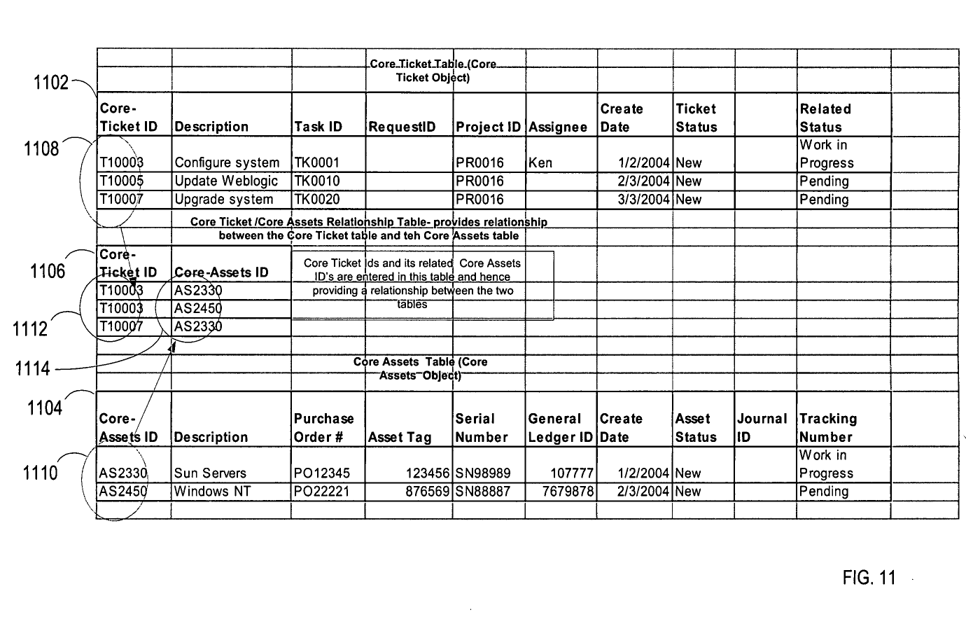

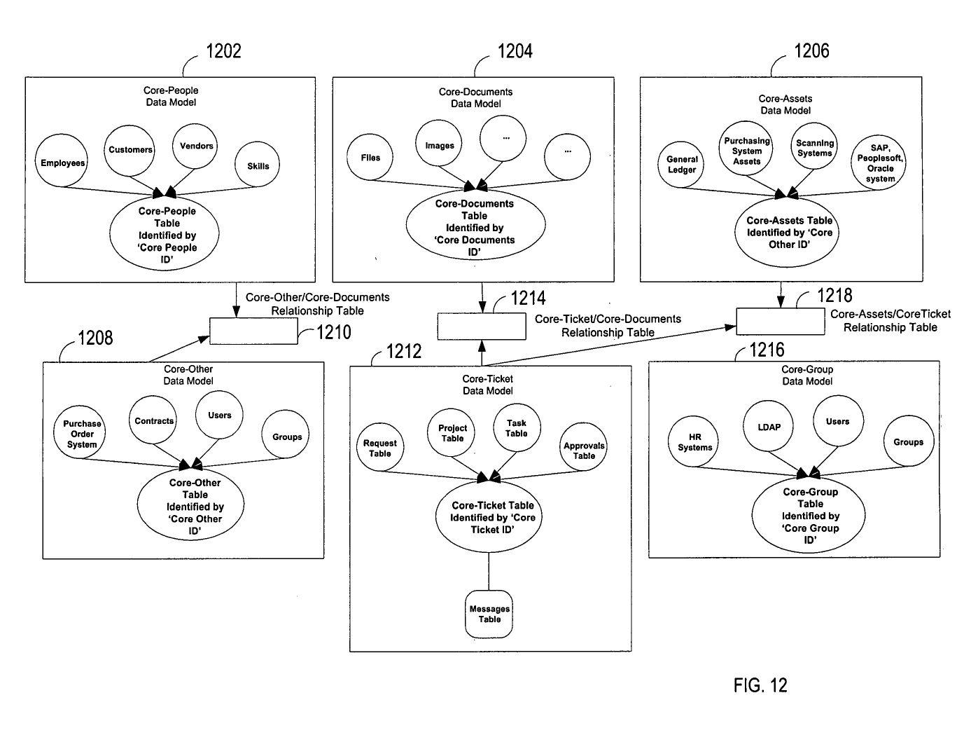

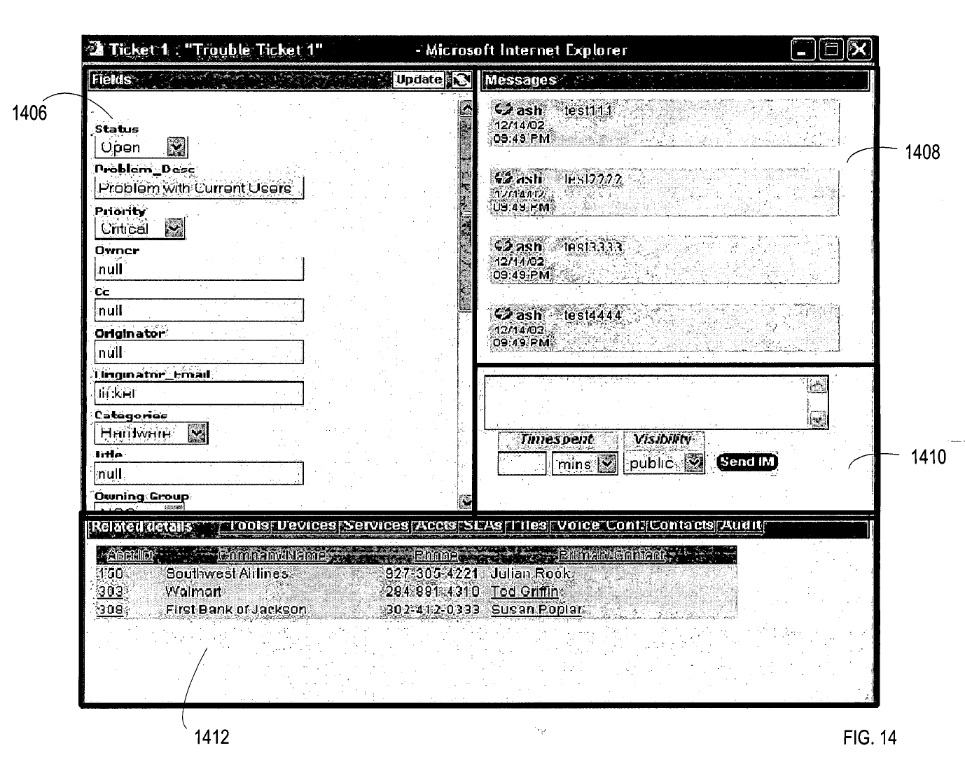

Another key component for maintaining a stable data model is the mechanism for establishing relationships between objects. Such a mechanism is referred to herein as a relationship object. The relationship object manages data-driven control over certain types of object relationships without the need for modifying existing data structures. Relationships and relationship objects are described in greater detail herein with reference to FIG. 3, FIG. 5, FIG. 11, FIG. 12, and FIG. 14.

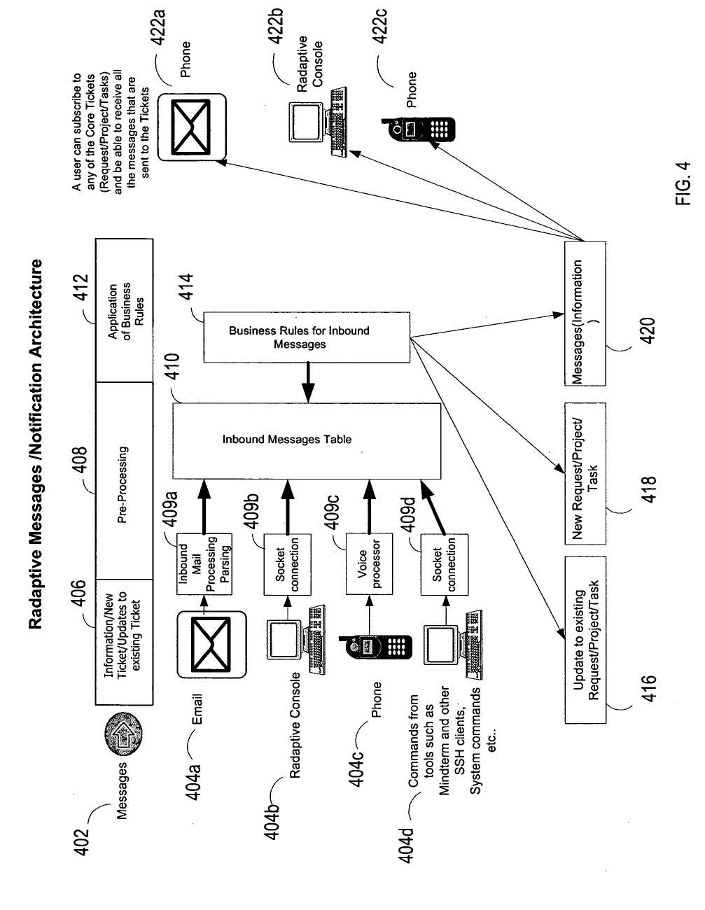

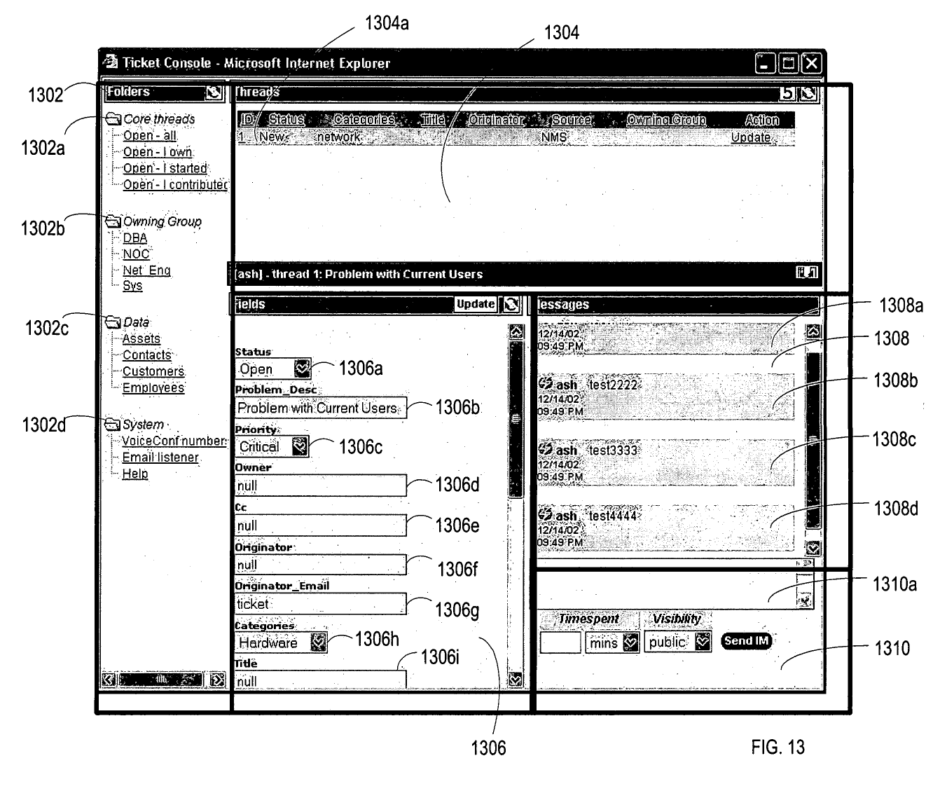

Yet another key system component is the mechanism that provides unified messaging. Such a mechanism is referred to herein as a message object. The foundation for the unified messaging component is the standard set of objects that represent the common denominator of any form of communications. Message objects are tied to a core object and can be instantiated by any combination of communication channels including email, instant messages, voice mail, or work flow application entries. Unified messaging and message objects are described in greater detail herein with reference to FIG. 2, FIG. 4, FIG. 13 and FIG. 14.

The system's unique capabilities stem from its common object model for managing communications and from its data-driven approach to managing business process tracking and automation. The system provides the basis for a common automation platform and unified user interface that can significantly increase user productivity and quality of collected business information.

Administration interfaces (user interfaces) allow authorized users to modify the control data in such a system. Such an approach allows rapid adaptation to changing business processes without the need for additional programming. The system is designed to maintain common intuitive interfaces for users making requests or for working the ensuing tasks.

The user interfaces of the system can be web-based, i.e., HTML-based user interfaces. The user interfaces of the system are based on four primary user roles:

Requester interface—The requester interface focuses on a data-driven wizard interaction for maximum efficiency and ease of use.

Worker interface—The worker interface is based on providing embedded communications and tools to enable users to perform much of their work within the context of the system. When work is performed within the context of the system, the work is simultaneously documented automatically as the work is being performed, thus obviating the need to manually document the work after the work is performed.

Management interface—The management interface is focused on providing access to comprehensive business process metrics.

Administrator interfaces—The administrator interfaces include a system administrator interface, a process administration interface, and a departmental administrator interface. Such administrator interfaces enable system, process, and departmental control data to be managed by designated administrative personnel.

According to certain embodiments, the worker interface is designed around the normalized project, request, task, message, and relationship objects. The worker interface leverages the common object structures in order to provide the user with a unified display. Such a unified display enables a single interface for communications and invocation of automation facilities for any type of task.

The system administrator interface enables the creation of business rules using a form-based wizard. Such business rules implement event-based data validation, system notification and automation.

The process administrator interface enables control data to be modified for controlling the types of requests that will be presented, the data elements that are required for submitting a particular type of request, and what tasks will be generated to fulfill that request.

The departmental administrator interface will allow control data to be modified that determines what data elements are required for specific types of tasks, what individuals are members of which workgroups, and which users have authority to approve requests for a given department.

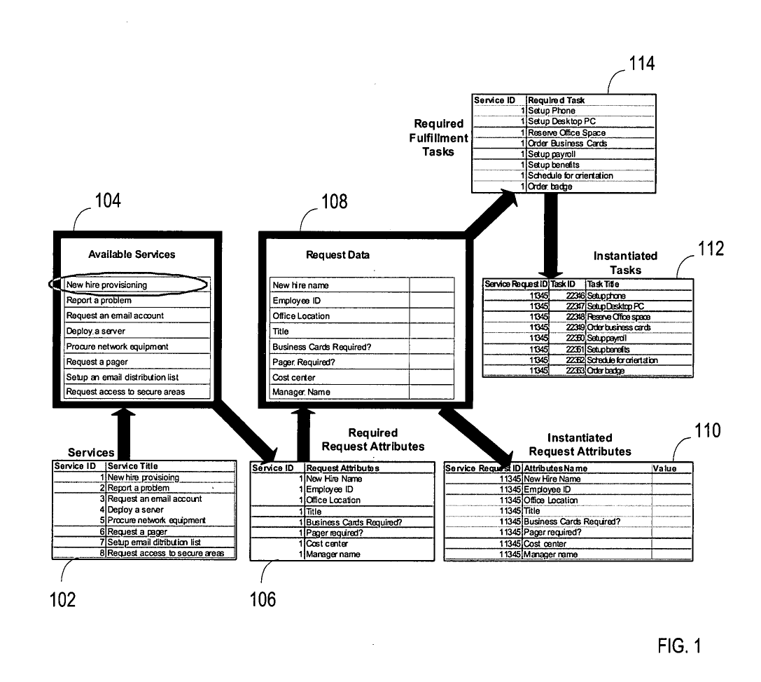

The application framework is illustrated in FIG. 1. FIG. 1 shows by way of example, the manner in which control data drives the request interface and the fulfillment tasks that are consequently spawned. The example demonstrates the manner in which dynamic data drives the workflow system. The requester is presented with a list of choices 104 generated from a Request object 102. Once a specific service is selected from list of choices 104, the system checks the data elements required for the selected service in the Required Request Attributes object 106. A page 108 is dynamically generated from this data to solicit the required data from the user. When the data is provided by the user, the data values are captured in the Instantiated Request Attributes object 110.

In addition to instantiating the attribute values for the request, tasks are instantiated in the Instantiated Tasks object 112 based on values specified for the particular type of request in the Required Fulfillment Tasks object 114. Task attributes are then collected using a similar technique thus allowing a greater level of customization to take place by using control data and dynamically created application pages, with no need for additional programming or changing the underlying data structures.

FIG. 2 illustrates key object classifications in a Core Object model, according to certain embodiments. Objects are used for logical description of an entity such as a Ticket. FIG. 2 shows a core object such as Core-Ticket Object 210 that provides for relationship between other objects such as Request table 202, Project table 204, Task table 206 and Approvals table 208. An object will correspond to a table in a relational database, hence the terms Object and Tables are used interchangeably. Other examples of objects are Human Resource Application tables, Peoplesoft Application table, SAP Inventory Manager table, etc.

Each object is identified by an object ID. For example, the Core-Ticket table 210 is identified by a core-ticket ID, the Request table 202 is identified by a Request ID, the Project table 204 is identified by a project ID, etc. Further, each table (object) includes a plurality of attributes. Attributes of the Project, Request, Task and Approvals Tables (objects) may be change as needed. At a minimum, the tables contain attributes corresponding to the Core Ticket table. There is a one-to-one relationship between each attribute in a given table to a corresponding attribute in the Core table.

There can be as many Tasks and Approval record entries in the Core Ticket Table. The message table 212 is an object that represents a distinct contribution to any type of a record in one or more tables related to the Core Ticket table such as the Project, Request, Approval or Task tables. There is a one-to-many relationship between a given core object and message object. For example, in FIG. 2, the given Core-ticket table can have many messages associated with it. The Messages table contains a list of all the messages that are generated in the application. The sources for Messages are Email, Instant Message clients, Fax and Voice.

A Relationship object exists for every Core Object to enable a typed, many-to-many relationship with any other Core Object. The Relationship object is covered in greater detail herein with reference to FIG. 3, FIG. 5, FIG. 11, FIG. 12, and FIG. 14.

FIG. 3 illustrates sample attributes of the Core-Ticket object and the Message object, according to certain embodiments. Core ticket table 302 includes attributes such as attributes 306. Message table 304 includes attributes such as attributes 308. Message table 304 is related to Core-ticket table 302 because the core-ticket ID 310 appears in both Core ticket table 302 and Message table 304. Such core attributes are consistent across every instantiation of the related objects and Message object, regardless of whether the objects are created by the system's request interface, a real-time messaging interface, or an external system API. For any external system, such as email or an external workflow application, a mapping table is used to map the external system's data structures to the system's thread (records) and message object format.

FIG. 4 is a schematic illustration of the Messaging architecture that provides an integrated messaging framework for uniform messaging capabilities, according to certain embodiments. In FIG. 4, incoming messages 402 are system or manually generated information that is sent or updated directly into the system. Messages 402 can be from any message type such as message types 404a-d. The incoming messages 402 are used for an input or update flow process 406. The incoming messages 402 are then sent through a pre-processing flow 408 (i.e., converted to an appropriate format). Examples of pre-processing include mail processing parsing 409a, socket connections 409b, 409d, and voice processing 409c. The inbound messages 402 are stored in inbound message table 410. A flow process 412 for applying business rules 414 is applied to the inbound messages 402 stored in message table 410. Sample results from applying business rules 414 to the inbound messages 402 are updates 416 to existing requests/projects/tasks, creations 418 of new requests/projects/tasks, storage 420 of the messages in the relevant message tables associated with the given core object. Further, notifications 422a-care sent based on subscriptions.

The following are examples of message types:

1. An email can be sent to the system by a user in order to create a new Request for obtaining a new piece of equipment. In this example, the text of the Email body will be stored in the Messages Table.

2. A user may like to post a question on the system Console related to the Project that he/she is working on.

3. A user may like to capture a conference call with respect to a problem and store the conference call along with the associated Task that was generated in the system to track the problem. The conference call can be saved as a wave file and then attached to the associated task.

4. A user may like to store all the Unix commands that were issued in an SSH client to fix a hardware problem and then store the issued commands along with a Task that was created in the system to track the hardware problem.

For purposes of explanation, assume that a user reports a new problem via email and the new problem needs to be tracked in the system. In such a case, the business rules are designed to automatically generate a new Task from the email from the user. In another example, assume that a user sends a detailed description in the body of the email regarding a problem that has already been logged and tracked in the system. In such a case, the email body is parsed and stored in the Messages table with a reference to the problem identified by a Task ID.

Further, a user can subscribe to a topic by selecting the appropriate record from the system Console. A topic can be a Project, Request or Task. Subscription to a topic indicates to the system that it must inform the user of any new messages that have been posted to that particular topic. Generally, all the messages that are posted to a particular topic (Project, Request or Task) will be displayed in the Messages window of the system Console. A user can reply to the messages via the console. The reply will be treated as an inbound message to the system.

The following table illustrates sample attributes of a ticket-core object. In other words, the core-ticket object refers to a table, in the relational database, called “Core Ticket” with the following attributes:

| Column Attribute | Type | Description |
|---|---|---|
| Core Ticket ID | Integer | |
| Display Column | String | Column Name that |
| | | needs to be |
| | | displayed when the |
| | | details of the Ticket |
| | | is exposed to a user |
| | | such as in a query |
| Title | String | |
| Assignee | String | |
| Owner | String | |
| Create Date | Date/Time | |
| Last Update | Date/Time | |
| Project ID | Integer | |
| Request ID | Integer | |
| Task ID | Task ID | |
| Ticket Type | String | |
| Core Status | String | Describes the current |
| | | condition of the |
| | | Ticket. For example, |
| | | if this were an entry |
| | | for a related Task, |
| | | the Ticket status |
| | | could be ‘In progress’ |
| Related Status | String | Describes the current |
| | | condition of the |
| | | related item. For |
| | | example, if this were |
| | | an entry for a related |
| | | Task, the Related |
| | | Status could be |
| | | ‘Need Approval’ |
| Source | String | Describes the origin |
| | | of the data - manual |
| | | or system generated |
| Assigned Group | String | |
| Priority | Integer | |

FIG. 5 illustrates the manner in which the Relationship object functions, according to certain embodiments. For purposes of explanation, assume that FIG. 5 shows the relationship between a Project and its associated Tasks. The Project records are stored in a Project Table and the Tasks in a Task Table. The Core-Ticket Table is used to relate the Project and its corresponding Tasks by creating an entry in the Core-Ticket Table for each Task record along with its Project ID's. The relationship must be implemented by storing the unique identifiers of the entries in the tables to be related, into a common table. Since the Project consists of 3 Tasks, there are 3 records in the Core-Ticket Table with the same Project ID (PR0016). Thus, in FIG. 5, the objects that are to be related are project table 502 and task table 506. The common table is core-ticket table 504. As an example, project id 508 “PR0016” in project table 502 is related to the associated tasks 510 shown in the task table 506 by entries in the core-ticket table 504. Thus, in core-ticket table 504, the task ID column 514 is populated with task IDs TK001, TK0010, TK0020 that correspond to project ID PR0016 as shown in project ID column 516 in core-ticket table 504.

By abstracting the relationship information into its own object, there is a level of insulation between the application logic and the underlying data model. Such a method eliminates required changes to the core data model when new objects, or new types of relationships, are introduced. Such an approach to managing relationships is consistent with the other aspects of the system that allow control data to customize the functionality provided by the system's applications.

FIG. 6 illustrates a Core-Group table 610 and the objects that the Core-Group table relates, according to certain embodiments. Core-Group table 610 contains relationship information between Human Resources System tables 602, LDAP based Directory system tables 604, Users table 606 and Groups table 608. Each of the objects (tables) has at least one record in the Core-Groups Table. Attributes of the Human Resources System tables 602, LDAP based Directory system tables 604, Users table 606 and Groups table 608 can be defined depending on the needs of the business. At a minimum, such tables (objects) contain attributes corresponding to the Core-Groups table 610. Each table is identified by a unique system generated id. Relationships between the Human Resources System table 602, LDAP based Directory system table 604, Users table 606 and Groups table 608 are provided by the Core Groups Table in a fashion as previously explained with reference to the Core-ticket example of FIG. 5.

FIG. 7 illustrates a Core-Other table 710 and the objects that the Core-Other table relates, according to certain embodiments. Core-Other table 710 contains relationship information between SLA Agreements table 702, Contracts table 704, tasks table 706, and maintenance agreements table 708. Each object has at least one record in the Core-Other Table. Attributes of the SLA Agreement table, Contracts table, Task and Maintenance Agreements will be defined as needed. At a minimum, the objects contain attributes corresponding to the Core-Other table. Each table is identified by a unique system generated id. Relationships between the SLA Agreements, Contracts, Tasks and Maintenance agreements objects are provided by the Core-Other Table in a fashion as previously explained with reference to the Core-ticket example of FIG. 5.

FIG. 8 illustrates a Core-Assets table 810 and the objects that the Core-Assets table relates, according to certain embodiments. Core-Assets table 810 contains relationship information between main asset table 802, Purchasing System asset table 804, Asset Scanning Systems table 806, and SAP/PeopleSoft/Oracle Financial Applications/or other systems tables that maintain Inventory information 808. The Relationships are maintained by ‘Main asset ID’, ‘Purchasing System ID’, ‘Scan ID’ and ‘Asset ID’. Each object has at least one record in the Core-Assets Table. Attributes of the Main assets table, Purchasing System table, Asset Scanning Systems table, and SAP/ PeopleSoft/Oracle Financial Applications/or other systems tables can defined based on the business needs at hand. At a minimum, the tables contain attributes corresponding to those in the Core-Assets table. Each table is identified by a unique system generated id. Relationships between the main assets table, Purchasing System table, Asset Scanning Systems table, SAP/PeopleSoft/Oracle Financial Applications/or other systems tables are provided by the Core Assets Table in a fashion as previously explained with reference to the Core-ticket example of FIG. 5.

FIG. 9 illustrates a Core-Documents table 910 and the objects that the Core-documents table relates, according to certain embodiments. Core-documents table 910 contains relationship information between Files table 902, Images table 904 and other Documents objects 906, 908 such as faxes, manuals, etc. Relationship is maintained by ‘File ID’, ‘Image ID’, etc. Each object has at least one record in the Core-Documents Table. Attributes of the Files and Images Table can be defined based on the business needs at hand. At a minimum, the tables contain attributes corresponding to those in the Core Documents table. Each table is identified by a unique system generated id. Relationships between the Files table, Images table, etc are provided by the Core-Documents Table in a fashion as previously explained with reference to the Core-ticket example of FIG. 5.

FIG. 10 illustrates a Core-People table 1010 and the objects that the Core-People table relates, according to certain embodiments. Core-People table 1010 contains relationship information between Employees table 1002, Customers table 1004, Vendors table 1006 and Skills table 1008. Relationship is maintained by ‘Employee ID’, ‘Customer ID’, ‘Vendor ID’ and ‘Skill ID’. Each object has at least one record in the Core-People Table. Attributes of the Employees, Customers, Vendors and Skills Tables can be defined based on the business needs at hand. At a minimum, the tables contain attributes corresponding to those in the Core-People table. Each table is identified by a unique system generated id. Relationships between the Employees, Customers, Vendors and Skills objects are provided by the Core-People Table in a fashion as previously explained with reference to the Core-ticket example of FIG. 5

It may be necessary to relate Core tables so that related information can be presented to the end user. For purposes of explanation, assume that a user may be interested in finding all the ‘Assets’ such as Hardware, Software, etc., that are related to a given Ticket. This can be achieved by providing a relationship between the Core-Ticket Table and the Core Assets table. FIG. 11 shows the relationship between Core objects, such as Core Ticket table 1102 and the Core Assets table 1104. In FIG. 11, such a relationship is shown in the relationship table 1106. Relationship table 1106 contains the Core Ticket ID 1112 and the corresponding Core Assets ID 1114. Core Ticket ID 1112 is the same as Core Ticket ID 1108. Similarly, Core Assets ID 1114 is the same as Core Assets ID 1110. The relationship table 1106 has a many-to-many relationship with the Core Ticket table 1102 and Core Asset Table 1104. The same concept can be applied in order to provide relationships between other Core tables (objects).

FIG. 12 illustrates a composite view if different core objects that are related by relationship tables. FIG. 12 shows a core-people table 1202, a core-documents table 1204, a core-assets table 1206, a core-other table 1208, a core-ticket table 1212, and a core-group table 1216. Relationship table 1210 contains relationship information that relates core-people table 1202 and core-other table 1208. Similarly, relationship table 1214 contains relationship information that relates core-documents table 1204 and core-ticket table 1212. Relationship table 1218 contains relationship information that relates core-assets table 1206 and core-group table 1216.

Integration of Tools such as MindTerm and other Unix Terminal Emulators

MindTerm is a software tool that allows for a SSH Session (Secure Shell Session) via an Applet. A SSH client is also referred to as a work-assist tool. This is similar to running exceed or SecureCRT terminal emulation software. According to certain embodiments, the system provides the ability of invoking MindTerm and other such emulators from within the System such that the associated interactions such as commands that are issued via the Terminal sessions logged in a Messages Table. The MindTerm tool can be launched from the ‘Related window’ of the system Console, as illustrated in FIG. 14 herein.

The information that is stored in the Messages Table can then be displayed on the Messages Window as shown in FIG. 14 herein. There are various options that can be specified for the interaction with MindTerm such as the ability to specify the option for capturing user issued commands, output from the command and specifying the number of the commands that can be captured.

The following steps comprise the process flow capturing information when using integration tools.

1. A user invokes the system Console.

2. The user selects the tab called ‘Tools’ in the ‘Related Details’ section of the console.

3. The user then selects an option to invoke the Mind Term applet similar to a Unix Terminal window that can be used to connect to other servers via SSH (Secure Shell). Secure shell is a protocol that enables secure Terminal sessions.

4. The system the enables the capture of all the interaction (both the command input and output) that are issued to the server via the Terminal Session and store it in a database.

5. The information in the ‘Messages’ window of the console is then refreshed after the Terminal Session is closed (or destroyed) when the information is saved in the database.

For the Mindterm session, the operations information from the terminal session can be saved in the 3 ways as described in item 1 of the Preferences Set-up below.

Preferences set-up:

1. The User may set an option where he/she might want to:

a. Simply capture the last 30 lines, for example <or any number of lines and is configurable via preference settings on the Server>from the session instead of capturing all the commands.

b. Alternatively—the user may want to only highlight the commands—similar to ‘Cut and Paste’ to save the specific commands.

c. Saving all the commands from the session.

2. The ‘Messages’ window is dockable/undockable—i.e., the user has the capability to expand the Window by undocking it to cover the entire screen.

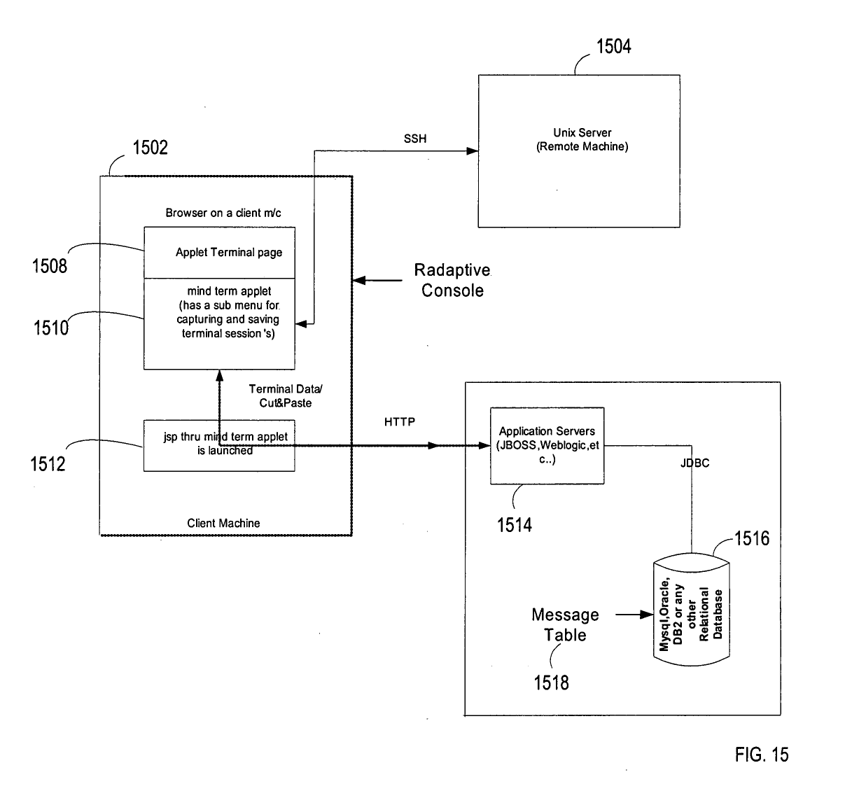

FIG. 15 is a schematic that illustrates the use of integrating tools and other terminal emulators, according to certain embodiments. FIG. 15 shows the system console 1502, a remote machine such as a Unix server 1504, application servers 1514, relational database 1516 and message table 1518. A user invokes a web browser and uses a terminal page 1508 to establish a terminal session on remote Unix server 1504 using SSH connections. The applet has a submenu 1510 for capturing and saving information (both command input an output) associated with the terminal session. Such information can be stored in relational database 1516. The MindTerm terminal applet page 1508 will be launched from a Java Server page. The MindTerm session that is captured will be routed to the Application server 1514 which in turn will route it to the relational database that it is connected to for eventual storage of the data in the Message table 1516

System Administration Components

There are several system administration components in this software system, including key subsystems for application generation, business rule generation, and normalizing external data. These components are detailed in the following sections.

Application Generator

An application generation facility is provided for creating all of the files required to produce database, web application server and internet browser based client components. The application generator enables all of the technical components to be created without conventional coding, but rather through a form-driven specification of the attributes that are desired for each particular application. The application generator will provide a facility to deploy applications that can be accessed via the Internet using a Web browser.

Business Rule Generator

A software system facility enables the creation of application logic in the form of business rules. The facility provides an interface to create the control data that enables event based data validation, notification, and automation. The business rules can be created using a form which can facilitate the construction of SQL statements (SQL) to retrieve and use data from a relational database such as Oracle, Sybase, Informix, MySQL, MSSQL and DB2.

The SQL statements can be created by using higher level constructs that can automatically construct the SQL statements. The SQL statements will then be automatically invoked by the system during run time in order to enforce the business rules.

Business Rules are constructed so that they can retrieve data from another system or update data in another database table.

Personal Business Rules

Personal Business Rules are business rules that apply only to an individual user of the System. The system will allow an individual to create rules that can only be invoked for the conditions that the user has set for himself or herself. An example of a rule that can be set is as follows.

“Notify me (user) whenever a trouble ticket is opened for a customer by the name of XYZ.”

If this personal business rule is to be executed, the system notifies (i.e., sends an email, for instance) whenever a Trouble Ticket (or a task) is created in the system for Customer XYZ.

Adapters

For every external workflow application, communications channel, or data source that will participate in the software system's data model, an adapter will provide the requisite access methods and attribute mapping formulas. For external workflow applications and communications channels, the external system's objects are mapped to this software system's common object model, in particular the Core-Ticket and Message objects. External data objects, such as ERP and CRM applications (Peoplesoft, Siebel, Oracle, SAP), will be mapped to a Proxy object in this software system.

Worker Interface Components

To address the user interface requirements for the system for users who are responsible for working tasks, Ul components are provided by the system for real time messaging, searching for request and task data, updating object attributes, accessing related data and invoking automation functions.

Message Console

The Message Console Ul provides a single interface to view all messages for all threads contained in the system. FIG. 13 shows the primary sub-windows of the Message Console, including:

Folders 1302—This area is used to enable the user to navigate the software system. Some of the functions that are made available for the user include searching and submitting request and task objects, system administration settings and report selection. Folders section 1302 includes core threads folder 1302a, Owning Group folder 1302b, data folder 1302c, and system folder 1302d.

Core-Ticket 1304 (Grid)—A grid shows the records (requests, tasks, projects, change requests etc . . . ) that were returned based on the selected folder.

Messages 1308—This sub-window shows the messages 1308a through 1308d that are related to either all of the threads contained in the thread grid or only those messages for the selected individual thread. All messages are pushed from the server and received by the user interface in real-time; therefore, no manual or automatic pull/polling mechanism is required to view new messages. The messages are ‘pushed’ to the Web browser by using an applet that maintains a socket connection with the client (the HTML Web browser).

Add Message 1310—This sub-window provides an input area 1310a to contribute a new message for an existing thread in real-time.

Fields 1306—This sub-window shows the attributes 1306a through 1306i for the selected thread.

Project/Request/Task/Approval Detail Forms

FIG. 14 depicts an example of a detail form. The Fields 1406, Messages 1408 and Add Message 1410 sub-windows that were described with reference to FIG. 13 above are also made available on the Detail Form for an individual Project/Request/Task/Approval record. There is also a Related Details 1412 sub-window that provides the user with access to all related tools, objects and audit logs that are available in this system.

The system provides a way to use these Ul components for a variety of custom forms based on the type of request or task. While the forms are customized for specific tasks, there is still a consistent set of task attributes that are collected for each type of task that enables all tasks to participate in with common system services.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for managing projects, requests, tasks, approvals and associated communications regardless of source of said projects, said requests, said tasks, said approvals, the method comprising the computer-implemented act of:
normalizing said projects, said requests, said tasks, said approvals and said associated communications based on a common data object model, wherein said common data object model enables logical relationships between a plurality of related objects and a message object associated with said common data object model.

2. The method of claim 1, wherein said common data object model comprises:
a core object;
a relationship object; and
said message object.

3. The method of claim 2, wherein records associated with said core object and said message object are instantiated by any combination of communications channels, including email, instant messaging, voice, and workflow application entries.

4. The method of claim 1, further comprising the act of:
using an automation facility that is based on said common data object model;
wherein said automation facility develops an application logic that is implemented by using a form-driven administration interface; and
wherein said automation facility automatically creates one or more business rules based on said application logic.

5. The method of claim 2, further comprising the act of:
using a common user interface that is based on said common data object model, wherein said common user interface is adapted for presenting a unified view of said related objects, said core object, said message object, and said relationship object using a GUI window with associated sub-windows.

6. The method of claim 5, wherein said common user interface is HTML web-based.

7. The method of claim 1, further comprising the act of:
using a data-driven mechanism for describing and instantiating said projects, said requests, said tasks, said approvals and associated data elements.

8. The method of claim 7, wherein said data-driven mechanism is adapted for one or more of:
collecting a first information based on said requests;
creating said tasks and related dependencies based on said requests;
collecting a second information based on each of said tasks;
driving one or more automation functions based on said tasks;
validating said associated data elements; and
sending notifications based on one or more events.

9. The method of claim 2, wherein said core object is of any type based on business objectives.

10. The method of claim 9, wherein said any type includes:
a core-ticket object type;
a core-group object type;
a core-other object type;
a core-assets object type;
a core-documents object type; and
a core-people object type;

11. The method of claim 1, wherein said plurality of related objects is of any type based on business objectives.

12. The method of claim 11, wherein said any type includes:
a request object type;
a project object type;
a task object type;
an approvals object type;
a human resources system object type;
an LDAP object type;
a users object type;
a group object type;
an SLA agreements object type;
a contracts object type;
a maintenance agreement object type;
a main asset object type;
a purchasing system asset object type;
a scanning system object type;
an inventory system object type;
a files object type;
an images object type;
a fax object type;
a employee object type;
a customer object type;
a vendor object type; and
a skills object type.

13. The method of claim 1, further comprising the act of:
using an integration mechanism for integrating input and output from integrating tools, work assist tools and terminal emulators into said common data object model.

14. The method of claim 13, wherein the act of integrating includes:
capturing input commands associated with using said work assist tools and terminal emulators;
capturing output associated with said input commands;
storing said captured input commands and said captured output in an associated message object.

15. The method of claim 1, further comprising the act of:
using a subscription mechanism for allowing end-users to subscribe to messages.

16. A common data object model for managing projects, requests, tasks, approvals and associated communications regardless of source of said projects, said requests, said tasks, said approvals, wherein said common data object model enables logical relationships between a plurality of related objects and a message object associated with said common data object model.

17. The common data object model of claim 16, wherein said common data object model comprises:
a core object;
a relationship object; and
said message object.

18. The common data object model of claim 17, wherein records associated with said core object and said message object are instantiated by any combination of communications channels, including email, instant messaging, voice, and workflow application entries.

19. The common data object model of claim 16, wherein said common data object model is associated with an automation facility; and
wherein said automation facility develops an application logic that is implemented by using a form-driven administration interface; and
wherein said automation facility automatically creates one or more business rules based on said application logic.

20. The common data object model of claim 17, wherein said common data object model is associated with a common user interface, wherein said common user interface is adapted for presenting a unified view of said related objects, said core object, said message object, and said relationship object using a GUI window with associated sub-windows.

21. The common data object model of claim 20, wherein said common user interface is web-based.

22. The common data object model of claim 16, wherein said common data object model is associated with a data-driven mechanism for describing and instantiating said projects, said requests, said tasks, said approvals and associated data elements.

23. The common data object model of claim 22, wherein said data-driven mechanism is adapted for one or more of:
collecting a first information based on said requests;
creating said tasks and related dependencies based on said requests;
collecting a second information based on each of said tasks;
driving one or more automation functions based on said tasks;
validating said associated data elements; and
sending notifications based on one or more events.

24. The common data object model of claim 17, wherein said core object is of any type based on business objectives.

25. The common data object model of claim 24, wherein said any type includes:
a core-ticket object type;
a core-group object type;
a core-other object type;
a core-assets object type;
a core-documents object type; and
a core-people object type;

26. The common data object model of claim 16, wherein said plurality of related objects is of any type based on business objectives.

27. The common data object model of claim 26, wherein said any type includes:
a request object type;
a project object type;
a task object type;
an approvals object type;
a human resources system object type;
an LDAP object type;
a users object type;
a group object type;
an SLA agreements object type;
a contracts object type;
a maintenance agreement object type;
a main asset object type;
a purchasing system asset object type;
a scanning system object type;
an inventory system object type;
a files object type;
an images object type;
a fax object type;
a employee object type;
a customer object type;
a vendor object type; and
a skills object type.

28. The common data object model of claim 16, wherein said common data object model is associated with an integration mechanism for integrating input and output from integrating tools, work assist tools and terminal emulators into said common data object model.

29. The common data object model of claim 28, wherein integrating includes:
capturing input commands associated with using said work assist tools and terminal emulators;
capturing output associated with said input commands;
storing said captured input commands and said captured output in an associated message object.

30. The common data object model of claim 16, wherein said common data object model is associated with a subscription mechanism for allowing end-users to subscribe to messages.
